(19) United States
(12) Patent Application Publication
(10) Pub. No.: US 2025/0200420 A1
(43) Pub. Date: Jun. 19, 2025

(54) AUTOMATED FORECASTING MODELS PROVIDER

(71) Applicant: HEWLETT PACKARD ENTERPRISE DEVELOPMENT LP, Spring, TX (US)

(72) Inventors: Paolo De Piante, Rome (IT); Anna Makarova, Cernusco sul Naviglio (IT); Manuel Prandini, Cernusco sul Naviglio (IT)

(21) Appl. No.: 18/538,269

(22) Filed: Dec. 13, 2023

(51) Int. Cl. G06N 20/00

(52) U.S. Cl. CPC G06N 20/00

(57) ABSTRACT

Examples of the presently disclosed technology provide end-to-end systems for automatically training, validating, selecting, and deploying forecasting models in response to fast changing data trends. Such an end-to-end system includes edge computing resources that stream data directly from customer data sources and detect drift between predictions of forecasting models deployed at the edge computing resources and corresponding time-series data derived from the streamed data. The end-to-end system also includes a central computing resource (e.g., a centralized, cloud-based computer cluster) that responds to the drift detections by automatically training, and validating instances of stored forecasting models using fresh time-series data derived from the streamed data. The fresh time-series data may be logically grouped into subsets of time-series data metrics—where each subset of time-series data metrics is associated with a common customer sub-system.

### BACKGROUND

Machine learning models may comprise algorithm-based computer programs trained to recognize patterns in data, and make predictions and/or classifications based on such learned pattern recognition.

As used herein, a forecasting model may refer to a machine learning model that processes historical and current/real-time information to predict feature outcomes. In many implementations, forecasting models utilize time-series data (i.e., data points indexed in time order) to make such predictions.

### BRIEF DESCRIPTION OF THE DRAWINGS

The present disclosure, in accordance with one or more various examples, is described in detail with reference to the following figures. The figures are provided for purposes of illustration only and merely depict examples.

FIGS. 1A-1B depict an example computing system for automatically training, validating, selecting, and deploying forecasting models in response to fast changing data trends, in accordance with various examples of the presently disclosed technology.

FIG. 2 illustrates an example computing resource for automatically training, validating, and selecting forecasting models, in accordance with various examples of the presently disclosed technology.

FIG. 3 illustrates an example edge computing resource for deriving subsets of time-series data metrics, detecting drift involving the subsets of time-series data metrics, and automatically deploying instances of new forecasting models trained to predict the (drifted) subsets of time-series data metrics, in accordance with various examples of the presently disclosed technology.

FIG. 4 depicts an example graph comparing predictions of forecasting models against actual/historical data the forecasting models are deployed to predict, in accordance with various examples of the presently disclosed technology.

FIG. 5 depicts a block diagram of an example computer system in which various of the examples described herein may be implemented.

The figures are not exhaustive and do not limit the present disclosure to the precise form disclosed.

### DETAILED DESCRIPTION

Forecasting models have become critical tools for many businesses as they are able to address/overcome future uncertainties using predictive analytics. However, business process-related data that forecasting models use to make predictions tends to grow and change rapidly. Changes in data trends (often caused by unexpected events) can lead to deteriorating prediction accuracy for forecasting models-resulting in financial losses for businesses that rely on them. For example, a forecasting model may be deployed to predict certain operational parameters for a machine at a manufacturing plant based on sensor data acquired from the machine. An unexpected event (e.g., a change of sensors on the machine, a non-sensor-related functional or structural modification to the machine, etc.) may cause prediction accuracy for the forecasting model to deteriorate. This can lead to financial losses for the manufacturing plant when certain business processes and/or business decisions are based on the increasingly inaccurate predictions of the forecasting model.

In the example above, even if deteriorating prediction accuracy of the forecasting model is detected early, many existing technologies still rely on a human data scientist to manually select a new forecasting model better-suited for the new/changed data trend. Prior to deployment, the data scientist would also generally have to initiate training and validation of the new forecasting model along with other potential alternatives. This prolonged, manual process often fails to keep pace with rapidly changing data trends-meaning that lower performing forecasting models (i.e., forecasting models having relatively lower prediction accuracy) are often deployed at inference/production for longer periods than optimal.

Related to above, many existing automation technologies in the predicative analytics field only focus on individual segments of a forecasting model pipeline (e.g., data acquisition, predictions at inference, model training, model validation, model selection/deployment, etc.). This lack of cohesion between disparate systems can lead to inefficiencies (e.g., data latencies between systems, reliance on manual data scientist input, etc.)—which can also cause delays in responding to rapidly changing data trends.

Against this backdrop, examples of the presently disclosed technology provide end-to-end systems for automatically training, validating, selecting, and deploying forecasting models in response to fast changing data trends. Such an end-to-end system includes edge computing resources (e.g., edge computing clusters associated with respective customers) that stream data directly from customer data sources (e.g., customer sub-systems) and detect drift involving time-series data derived from the streamed data. The end-to-end system also includes a central computing resource (e.g., a centralized, cloud-based computer cluster) that responds to the drift detections by automatically training, and validating instances of stored forecasting models (e.g., potentially numerous forecasting models stored in the Darts Library) using fresh (i.e., recent/approximately real-time) time-series data derived from the streamed data. The fresh time-series data may be logically grouped into subsets of time-series data metrics (i.e., multiple time-series data metrics logically grouped according to a heuristic). In some implementations, each subset of time-series data metrics may be associated with a common customer sub-system (e.g., a subset of time-series data metrics associated with the machine from the manufacturing plant example described above). Here, logically grouping time-series data metrics into subsets can improve forecasting model training/validation efficiency.

For example, a system of the presently disclosed technology may comprise a central computing resource (e.g., a centralized, cloud-based computer cluster) and a series of edge computing resources (e.g., edge computing clusters), including a first edge computing resource. Responsive to detection of drift involving time-series data (e.g., a subset of time-series data metrics) that a first forecasting model is deployed at the first edge computing resource to predict, the central computing resource can: (1) train instances of stored forecasting models using (fresh) training time-series data derived from the time-series data; (2) compare predictions of the trained instances of the stored forecasting models to corresponding (fresh) validation time-series data also derived from the time-series data; (3) based on the comparisons, determine that a trained instance of a second forecasting model has lowest prediction error for predicting the time-series data among the trained instances of the stored forecasting models; and (4) responsive to determining the trained instance of the second forecasting model has a lower prediction error for predicting the time-series data than the first forecasting model, update a model registry database of the central computing resource with parameters of the trained instance of the second forecasting model.

Relatedly, responsive to the central computing resource updating the model registry database with the parameters of the trained instance of the second forecasting model, the first edge computing resource can: (a) download the parameters of the trained instance of the second forecasting model from the model registry database; and (b) deploy the trained instance of the second forecasting model for predicting the time-series data. In various implementations, the first edge computing resource may also detect the drift involving the time-series data-which triggers the forecasting model training, validation, and selection described in the previous paragraph. In some implementations, the first edge computing resource can detect the drift involving the time-series data by comparing, within a time interval, historical predictions of the first forecasting model with corresponding portions of the time-series data.

As alluded to above, in certain implementations the time-series data may comprise a subset of time-series data metrics which are logically grouped together for more efficient forecasting model training/validation. In these implementations, the first edge computing resource may execute machine-readable instructions of a data switch process to: (i) stream data from a customer (e.g., data from machines of the manufacturing plant example described above); (ii) derive the subset of time-series data metrics from the data streamed from the customer; (iii) upload the subset of time-series data metrics to a time-series database of the first edge computing resource; and (iv) upload the subset of time-series data metrics to a time-series database of the central computing resource. In some implementations, deriving the subset of time-series data metrics from the data streamed from the customer may comprise: (a) indexing data points of the data in time order to generate time-series data metrics; and (b) logically grouping the subset of time-series data metrics together according to a heuristic. In various implementations the heuristic may comprise logically grouping time-series data metrics derived from a common customer sub-system (e.g., a respective machine of a customer's manufacturing plant) together as a subset of time-series data metrics.

Leveraging the data switch process of the first edge computing resource, the system can ensure that the time-series data metrics used to train and validate instances of stored forecasting models remains relatively fresh. Accordingly, the system can respond to rapidly changing data trends more quickly than potential alternative technologies that do not stream real-time (or approximately real-time) data for training and validating forecasting models. Relatedly, by (1) logically grouping time-series data metrics into respective subsets of time-series data metrics, and (2) training, validating, and selecting instances of forecasting models using these subsets of (logically grouped) time-series data metrics—the system can train/validate/select forecasting models more efficiently across a wide array of customer sub-systems/use-cases. The other edge computing resources of the system may comprise similar data switch processes executable to stream real-time (or approximately real-time) data from customers and/or derive subsets of time-series data metrics in the same/similar manner.

In some implementations, the central computing resource may execute machine-readable instructions of a model scheduler process operable to: (a) retrieve model training and validation tasks from a task database of the central computing resource, wherein a first model training and validation task utilizes the time-series data (e.g., a subset of time-series data metrics); and (b) assign the model training and validation tasks to model listener processes, wherein the first model training and validation task is assigned to a first model listener process. Each model training and validation task may be associated with a respective customer sub-system—and may utilize a respective subset of time-series data metrics associated with the respective customer sub-system. Here, the central computing resource can execute machine-readable instructions of the model scheduler process to assign the model training and validation tasks to the model listener processes in parallel to improve forecasting model training and validation speed/efficiency across many customer sub-systems/use-cases. The central computing resource may also execute machine-readable instructions of the model listener processes, including the first model listener process. For example, the central computing resource can execute machine-readable instructions of the first model listener process to perform the first model training and validation task.

It should be understood that in many practical implementations the above-described system may comprise thousands of edge computing resources (or more). These thousands of edge computing resources may be associated with thousands of customer sub-systems/customer use-cases (or more) which each produce enormous amounts of data. Individually training and validating multiple instances of forecasting models to make predictions based on fresh time-series data metrics derived from these thousands of customer sub-systems/customer use-cases is a serious undertaking. However, leveraging particularized computing architectures (e.g., the data switch processes of the edge computing resources that can be executed to stream/process real-time (or approximately real-time) customer data, the model scheduler process of the central computing resource that can be executed to schedule/assign thousands of model training and validation tasks to thousands of model listener processes in parallel, the thousands of model listener processes that can be executed to perform assigned model training and validation tasks in parallel), the system can tackle this enormous data processing task with speed and efficiency orders of magnitude greater than potential manual alternatives.

As alluded to above, examples of the presently disclosed technology provide many advantages over existing technologies. For example, by automatically training, validating, selecting, and deploying forecasting models in response detected occurrences of drift, examples can respond to fast changing data trends more rapidly than existing technologies that require manual/human data scientist input. Such fast response time can improve outcomes for businesses that rely on forecasting model predictions. Relatedly, by providing end-to-end systems that manage all (or at least many) segments of a forecasting model pipeline (e.g., data acquisition, predictions at inference, model training, model validation, model selection/deployment, etc.), examples can further increase efficiencies in the technical field of computing-based predictive analytics (e.g., reduce data latencies between computing systems, reduce power consumption and processing times, etc.).

Examples of the presently disclosed technology are now described in conjunction with the following figures.

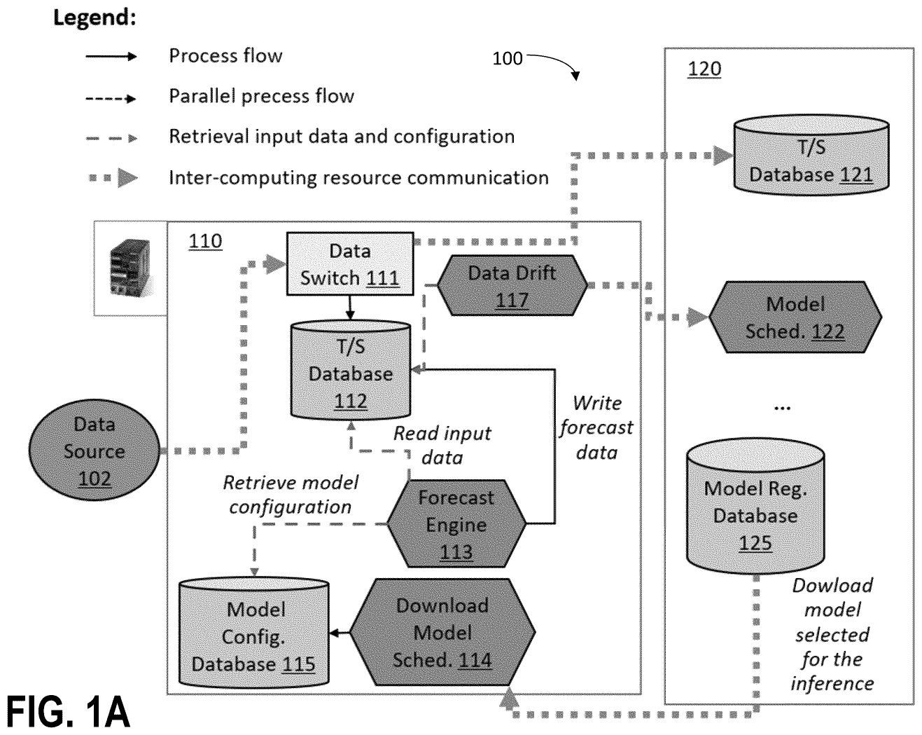

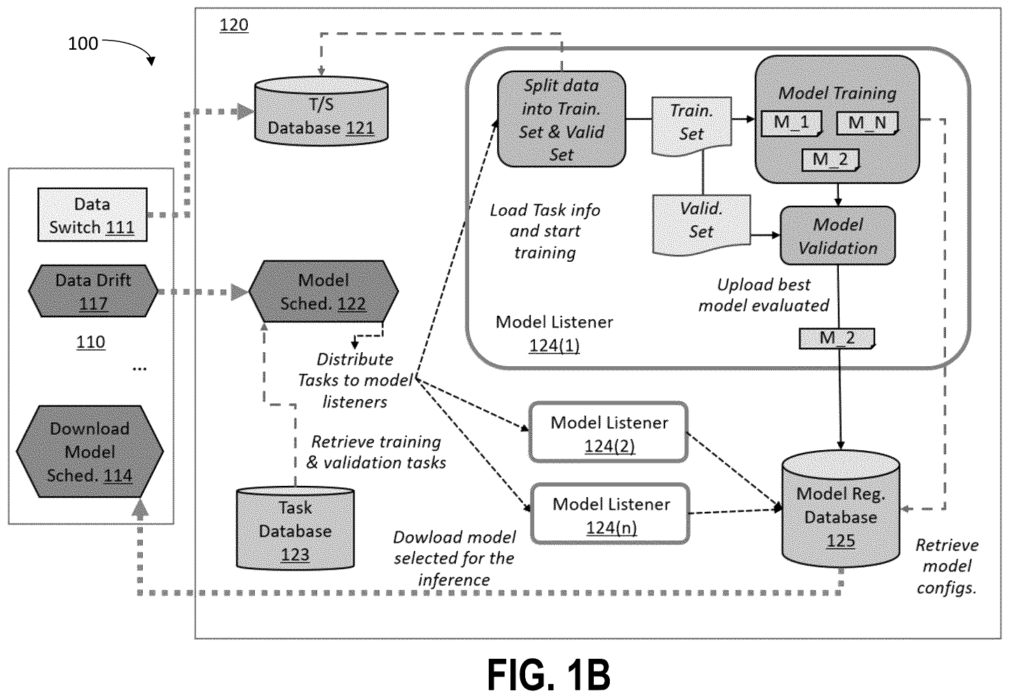

FIGS. 1A-1B depict an example computing system 100 for automatically training, validating, selecting, and deploying forecasting models in response to fast changing data trends, in accordance with various examples of the presently disclosed technology.

Computing system 100 comprises an edge computing resource 110 and a central computing resource 120. While not depicted in FIGS. 1A-1B, computing system 100 may comprise additional (and in various implementations, many additional) edge computing resources of the same/similar architecture as edge computing resource 110. For brevity, central computing resource 120 is only partially depicted in FIG. 1A. Likewise, edge computing resource 110 is only partially depicted in FIG. 1B.

Before describing components of computing system 100 in more detail, a high-level operational overview of computing system 100 may be instructive.

As depicted, edge computing resource 110 can execute a data switch process 111 to: (i) stream data from data source 102 (here data source 102 may be associated with a first customer); (ii) derive subsets of time-series data metrics from the streamed data; (iii) upload the subsets of time-series data metrics to a time-series database 112 of edge computing resource 110 (in some implementations time-series database 112 may operate as a cache); and (iv) upload the subsets of time-series data metrics to a time-series database 121 of central computing resource 120. As alluded to above, edge computing resource 110 can execute data switch process 111 to derive the subsets of time-series data metrics by: (a) indexing data points of the data streamed from data source 102 in time order to generate time-series data metrics; and (b) logically grouping subsets of time-series data metrics together according to a heuristic. In various implementations the heuristic may comprise logically grouping time-series data metrics derived from a common customer sub-system (e.g., a respective machine of a first customer's manufacturing plant) together as a subset of time-series data metrics.

As depicted, edge computing resource 110 can execute a forecast engine process 113 to manage deployment of one or more forecasting models. In certain implementations, a respective forecasting model can be used to make predictions based on a respective subset of time-series data metrics stored in time-series database 112. Such predictions can drive business processes and/or business decisions for a first customer associated with edge computing resource 110. For example, forecast engine process 113 may be executed to deploy a first forecasting model to make predictions based on a first subset of time-series data metrics. Relatedly, forecast engine process 113 may be executed to deploy a second forecasting model to make predictions based on a second subset of time-series data metrics. Data switch process 111 may be executed to derive the first subset of time-series data metrics from data streamed from a first customer sub-system. The first customer sub-system may comprise a machine of a first customer's manufacturing plant and the data streamed from the first machine may relate to operational parameters of the machine. Data switch process 111 may be executed to derive the second subset of time-series data metrics from data streamed from a second customer sub-system. The second customer sub-system may comprise a second machine of the first customer's manufacturing plant and the data streamed from the second machine may relate to operational parameters of the second machine. Predictions made by the first and second forecasting models can be used to drive manufacturing processes/manufacturing decisions at the first customer's manufacturing plant.

In certain implementations, prior to deploying forecasting models to make predictions, edge computing resource 110 can execute forecast engine process 113 to verify that the time-series data metrics stored in time-series database 112 are sampled from a common time interval (sometimes referred to as a “resampling operation”). Performing this resampling operation can ensure that the data being used to make predictions is temporally appropriate.

As depicted, edge computing resource 110 can execute a drift detection process 117 to detect drift involving the first subset of time-series data metrics and/or the second subset of time-series data metrics. As used herein “drift” may refer to statistical properties of a time-series data metric (or time-series data metrics) that change over time in unforeseen ways. These unforeseen changes can cause predictions of a forecasting model deployed to predict the drifting time-series data metric (or time-series data metrics) to deteriorate. Accordingly, in certain implementations drift detection process 117 can be executed to detect drift involving the first subset of time-series data metrics by comparing, within a time interval, historical predictions of the first forecasting model to corresponding portions of the first subset of time-series data metrics (it should be understood that in other implementations such data drift may be detected using other techniques such as a using Kolmogorov-Smirnov (K-S) test, using a Population Stability Index, using the Page-Hinkley method, or using other drift detection techniques/algorithms). In some implementations, in response to drift being detected, drift detection process 117 can be executed to send a drift detection event to central computing resource 120 (or more specifically, a model scheduler process 122 of central computing resource 120). The drift detection event can indicate that drift has been detected and central computing resource 120 (or more specifically, a model scheduler process 122 of central computing resource 120) should initiate training of instances of stored forecasting models M_1-M_N to replace the first forecasting model.

Accordingly, responsive to detection of drift involving the first subset of time-series data metrics (e.g., in response to receiving a drift detection event indicating that drift has been detected), central computing resource 120 can execute model scheduler process 122 to retrieve a model training and validation task from task database 123 of central computing resource 120. Model scheduler process 122 can then be executed to assign the model training and validation task to model listener process 124 (1) of central computing resource 120. Model listener process 124 (1) can be executed to perform the model training and validation task by training instances of stored forecasting models M_1-M_N using (fresh) training time-series data derived from the first subset of time-series data metrics (as depicted, model listener process 124 (1) can be executed to retrieve the first subset of time-series data metrics from time-series database 121, and split the first subset of time-series data metrics into the training time-series data and validation time-series data). Model listener process 124 (1) can then be executed to compare predictions of trained instances of stored forecasting models M_1-M_N to corresponding (fresh) validation time-series data also derived from the first subset of time-series data metrics. Based on these comparisons, model listener process 124 (1) can be executed to determine that the trained instance of stored forecasting model M_2 has lowest prediction error for predicting the first subset of time-series data metrics among the trained instances of stored forecasting models M_1-M_N. Responsive to determining the trained instance of stored forecasting model M_2 has a lower prediction error for predicting the first subset of time-series data metrics than the first forecasting model, model listener process 124 (1) can be executed to update a model registry database 125 of central computing resource 120 with parameters of the trained instance of stored forecasting model M_2.

Responsive to central computing resource 120 updating model registry database 125 with the parameters of the trained instance of stored forecasting model M_2, edge computing resource 110 can execute a download model scheduler process to download the parameters of the trained instance of stored forecasting model M_2 and upload such parameters to a model configuration database 115 of edge computing resource 110. Forecast engine process 113 can then be executed to retrieve the parameters of the trained instance of stored forecasting model M_2 from model configuration database 115 and deploy the trained instance of stored forecasting model M_2 to predict the first subset of time-series data metrics. In this example, the trained instance of stored forecasting model M_2 may replace the first forecasting model which became less suited for predicting the post-drift first subset of time-series data metrics.

Specific components of computing system 100 are described in greater detail below.

As alluded to above, computing system 100 comprises a central computing resource 120 and one or more edge computing resources, including edge computing resource 110. As used herein, a computing resource (e.g., edge computing resource 110, central computing resource 120, etc.) may refer to one or more physical or logical/virtual computing devices. In certain implementations, a computing resource may comprise a computing cluster. For example, edge computing resource 110 may comprise an edge computing cluster and central computing resource 120 may comprise a central computing cluster (e.g., a central, cloud-based computing cluster). As used herein, a computing cluster may refer to a set of physical computing devices that work together so that they can be viewed as a single computing system. Components of computing clusters-sometimes referred to as computing nodes—may be connected to each other via networks (e.g., fast local area networks (LANs)). Each computing node of a computing cluster may comprise a physical computing device running its own instance of an operating system. Examples of computing devices can include a server computer, a laptop, a controller, and Internet-of-Things (IoT) device, or any other computing device capable of processing data. In some implementations, computing nodes of a common computing cluster utilize the same/similar hardware and operating system, although this need not be the case. In general, a computing cluster can improve performance and availability as compared to a single computing device. The computing cluster can also be more cost-effective than a single computing device of comparable speed/availability.

As depicted, edge computing resource 110 and central computing resource 120 can execute certain computing processes. For example, edge computing resource 110 can execute a data switch process 111, a forecast engine process 113, and a download model scheduler process 114. Likewise, central computing resource 120 can execute a model scheduler process 122 and model listener processes 124 (1)-(n). As used here a “computing process” (sometimes abbreviated to “process”) may refer to an instance of a computer program that is executed via one or more “computing threads.” As used herein a “computing thread” (sometimes abbreviated to “thread”) may refer to a minimal sequence of programmed instructions that a computing processor executes. Accordingly, edge computing resource 110 can execute machine-readable instructions of each of its constituent computing processes. Likewise, central computing resource 120 can execute machine-readable instructions of each of its constituent computing processes.

As depicted, edge computing resource 110 and central computing resource 120 may further comprise certain databases. For example, edge computing resource 110 may comprise a time-series database 112 (which in certain implementations may operate as a cache) and a model configuration database. Likewise, central computing resource 120 may comprise a time-series database 121, a model registry database 125, and a task database 123. As used herein, a database may refer to an organized collection of data stored in a computing device. In many cases, databases are specially organized for rapid search and retrieval by computing devices.

In various implementations, edge computing resource 110 and central computing resource 120 may comprise computing clusters implemented in containerized environments. For example, edge computing resource 110 may comprise a computing cluster that implements/executes its constituent processes (e.g., data switch process 111, forecast engine process 113, and download model scheduler process 114) as micro-services within containers. Likewise, central computing resource 120 may comprise a computing cluster that implements/executes its constituent processes (e.g., model scheduler process 122 and model listener processes 124(1)-(n)) as micro-services within containers. In these examples, the processes/micro-services can be managed by a container orchestrator, such as Kubernetes. The databases of edge computing resource 110 and central computing resource 120 may also be implemented using containers, and may be likewise managed by a container orchestrator.

Referring now to edge computing resource 110, edge computing resource 110 can be associated with a first customer, and may be implemented at a physical location of the first customer. For example (and as alluded to above), edge computing resource 110 may be implemented at a manufacturing plant of the first customer. In implementations where computing system 100 comprises additional edge computing resources, each additional edge computing resource may be associated with/implemented at a physical location of a respective additional customer.

As used herein, edge computing may refer to a distributed computing paradigm that brings data processing and/or data storage closer to locations where the data being processed/stored is actually produced. For example (and as alluded to above), edge computing resource 110 may be implemented at the first customer's manufacturing plant, and may process/store data obtained from machines of the manufacturing plant. In certain implementations, edge computing resource 110 may be incorporated/implemented in one or more of such machines.

Edge computing can reduce data latencies (and related inefficiencies) by bringing data processing/storage closer to data sources. Accordingly, by performing certain data processing steps at edge computing resource 110 (e.g., deriving subsets of time-series data metrics, deploying forecasting models at inferences), computing system 100 can improve efficiency by reducing data latencies (and related inefficiencies).

For example, edge computing resource 110 can execute data switch process 111 to stream data from a data source 102. In various implementations, data source 102 may be associated with one or more customer sub-systems (e.g., a first customer sub-system, a second customer sub-system, etc.). For instance, in the manufacturing plant example, data source 102 may be associated with one or more machines of the manufacturing plant, where each machine comprises a respective customer sub-system. In certain implementations, edge computing resource 110 can execute data switch process 111 to stream data from multiple data sources (e.g., a data source 103, a data source 104, etc.) of the first customer. These additional data sources may be associated with additional sub-systems of the first customer.

Data switch process 111 can be executed to stream raw (or pre-processed) data from data source 102. As alluded to above, data switch process 111 (or another computing process of edge computing resource 110) can be executed to convert the data streamed from data source 102 into a more useful/compatible format for forecasting model consumption at inference or during training. For example, data switch process 111 (or another computing process of edge computing resource 110) can be executed to derive subsets of time-series data metrics from the data streamed from data source 102. In some implementations, deriving the subset of time-series data metrics from the data streamed from data source 102 may comprise: (a) indexing data points of the data in time order to generate time-series data metrics; and (b) logically grouping subsets of time-series data metrics together according to a heuristic. In various implementations the heuristic may comprise logically grouping time-series data metrics derived from a common customer sub-system (e.g., a respective machine of the first customer's manufacturing plant) together as a subset of time-series data metrics.

As used herein, a time-series data metric may refer to data points indexed in time order. Illustrative examples of time-series data metrics may comprise: (1) time-indexed temperature of London; (2) time-indexed temperature of Berlin; (3) time-indexed humidity of London; (4) time-indexed humidity of Berlin; (5) time-indexed voltage of a first temperature sensor in a first machine; (6) time-indexed voltage of a first temperature sensor in a second machine; (7) time-indexed voltage of a second temperature sensor in the first machine; (8) time-indexed voltage of a second temperature sensor in the second machine; (9) time-indexed data obtained from a first CRM application; (10) time-indexed data obtained from a second CRM application; etc.

As used herein, a subset of time-series data metrics may comprise one or more time-series data metrics which are logically grouped according to a heuristic (such heuristic may be user-defined or automatically generated by computing system 100). Illustrative examples of subsets of time-series data metrics may comprise: (1) a subset of time-series data metrics comprising environmental parameters in London (e.g., a first time-series data metric comprising time-indexed temperature of London, a second time-series data metric comprising time-indexed humidity of London, a third time-series data metric comprising time-indexed SO₂ levels of London, etc.); (2) a subset of time-series data metrics comprising environmental parameters in Berlin (e.g., a first time-series data metric comprising time-indexed temperature of Berlin, a second time-series data metric comprising time-indexed humidity of Berlin, a third time-series data metric comprising time-indexed SO₂ levels in Berlin, etc.); (3) a subset of time-series data metrics comprising temperatures in major European cities (e.g., a first time-series data metric comprising time-indexed temperature of London, a second time-series data metric comprising time-indexed temperature of Berlin, a third time-series data metric comprising time-indexed temperature of Rome, etc.); (4) a subset of time-series data metrics comprising operational parameters of a customer's first machine (e.g., a first time-series data metric comprising time-indexed voltage of a first temperature sensor of the first machine, a second time-series data metric comprising time-indexed voltage of a second temperature sensor of the first machine, etc.); (5) a subset of time-series data metrics comprising operational parameters of a customer's second machine (e.g., a first time-series data metric comprising time-indexed voltage of a first temperature sensor of the second machine, a second time-series data metric comprising time-indexed voltage of a second temperature sensor of the second machine, etc.); (6) a subset of time-series data metrics comprising applications belonging to a customer's CRM domain (e.g., a first time-series data metric comprising time-indexed data obtained from a first CRM application, a second time-series data metric comprising time-indexed data obtained from a first CRM application, etc.).

As alluded to above, by (1) logically grouping time-series data metrics into respective subsets of time-series data metrics, and (2) training, validating, and selecting instances of forecasting models using these subsets of (logically grouped) time-series data metrics—computing system 100 can train/validate/select forecasting models more efficiently across a wide array of customer sub-systems/use-cases.

As depicted in FIGS. 1A-1B, data switch process 111 can be executed to: (i) upload the subsets of time-series data metrics to a time-series database 112 of edge computing resource 110; and (ii) upload the subsets of time-series data metrics to a time-series database 121 of central computing resource 120. In some implementations, time-series database 112 can operate as a cache or similar short-term memory database. This may be the case because the time-series data utilized within edge computing resource 110 will generally be relatively fresh/current to improve prediction accuracy.

As depicted, edge computing resource 110 also comprises a forecast engine process 113. Forecast engine process 113 (e.g., a Python computing process) can be executed to read/load subsets of time-series data metrics from time-series database 112 and select forecasting models stored in model configuration database 115 which are best-suited to predict respective subsets of time-series data metrics. For example, forecast engine process 113 may be executed to determine that a first forecasting model stored in model configuration database 115 is best suited to predict a first subset of time-series data metrics. Relatedly, forecast engine process 113 may be executed to determine that a second forecasting model stored in model configuration database 115 is best suited to predict a second subset of time-series data metrics, and so on. Forecast engine process 113 can be executed to upload parameters of selected forecasting model(s) from model configuration database 115 and deploy the selected forecasting model(s) to make predictions based on the subsets of time-series data metrics data stored/cached in time-series database 112. In some implementations, forecast engine 113 can be executed to write/upload predictions of the selected forecasting model(s) to time-series database 112 as well.

As alluded to above, drift detection process 117 can be executed to detect drift involving subsets of time-series data metrics stored in time-series database 112. For example, drift detection process 117 can be executed to detect drift involving a first subset of time-series data metrics. The detected drift involving the first subset of time-series data metrics may involve one or more of the constituent time-series data metrics of the first subset of time-series data metrics. In some examples, drift involving a first time-series data metric of a subset may suggest/anticipate drift in other time-series data metrics of the subset. As alluded to above, “drift” may refer to statistical properties of a time-series data metric (or time-series data metrics) that change over time in unforeseen ways. These unforeseen changes can cause predictions of a forecasting model deployed to predict the drifting time-series data metric (or time-series data metrics) to deteriorate. Accordingly, in certain implementations drift detection process 117 can be executed to detect drift involving the first subset of time-series data metrics by comparing, within a time interval, historical predictions of a first forecasting model deployed to predict the first subset of time-series data metrics to corresponding portions of the first subset of time-series data metrics. In other implementations however such data drift may be detected using other techniques such as a using Kolmogorov-Smirnov (K-S) test, using a Population Stability Index, using the Page-Hinkley method, or using other drift detection techniques/algorithms. In some implementations, in response to drift being detected, drift detection process 117 can be executed to send a drift detection event to central computing resource 120 (or more specifically, model scheduler process 122 of central computing resource 120). The drift detection event can indicate that drift has been detected for the first subset of time-series data metrics and that central computing resource 120 (or more specifically, model scheduler process 122 of central computing resource 120) should initiate training of instances of stored forecasting models M_1-M_N to replace the first forecasting model. In certain implementations, detecting drift for a single time-series data metric may alone not be sufficient to trigger the drift detection event being sent. For instance, in these implementations drift may need to be detected for multiple time-series data metrics within the first subset of time-series data metrics before drift detection process 117 is executed to send the drift detection event. In some implementations, each time-series data metric within the first subset of time-series data metrics may be assigned a weight measuring its relative level of importance. Such weights can be compared against a threshold to determine whether to send a drift detection event. For example, detecting drift for a single time-series data metric with a weight (or other parameter) that exceeds a threshold may be sufficient to trigger sending of a drift detection event. By contrast, drift may need to be detected for multiple time-series data metrics with weights below the threshold before a drift detection event is sent.

In response to detection of drift involving the first subset of time-series data metrics (e.g., in response to receiving a drift detection event), central computing resource 120 can train, validate, and select an instance of forecasting model M_2 to predict the (drifted) first subset of time-series data metrics. After the trained instance of forecasting model M_2 has been selected and uploaded to model registry database 125 of central computing resource 120, edge computing resource 110 may be notified. For example, model registry database 125 can transmit a notification callback to download model scheduler process 114 to notify edge computing resource 110 that a new configuration file storing the trained parameters of forecasting model M_2 has been uploaded to model registry database 125. In certain examples, the notification callback may identify that the trained instance of forecasting model M_2 was selected to predict the (drifted) first subset of time-series data metrics. Accordingly, download model scheduler process 114 can be executed to download the new configuration file and upload the parameters of the trained instance of forecasting model M_2 to model configuration database 115. Forecast engine process 113 can then be executed to retrieve the parameters of the trained instance of forecasting model M_2 and deploy the trained instance of forecasting model M_2 to predict the (drifted) first subset of time-series data metrics.

Referring now to central computing resource 120, central computing resource 120 comprises a model scheduler process 122. Model scheduler process 122 can be executed to effectively manage/orchestrate forecasting model training and validation in an analogous manner to how forecast engine process 113 can be executed to manage/orchestrate deployment of forecasting models at inferences.

For example, edge computing resource 110 may notify model scheduler process 122 (or more generally notify central computing resource 120) that drift has been detected for the first subset of time-series data metrics. Responsive to such drift detection, model scheduler process 122 can be executed to retrieve a first model training and validation task from task database 123 (e.g., a relational database that stores forecasting model and validation tasks) of central computing resource 120. Model scheduler process 122 can then be executed to assign the first model training and validation task to model listener process 124(1). In an analogous manner, edge computing resource 110 may notify model scheduler process 122 (or more generally notify central computing resource 120) that drift has been detected for a second subset of time-series data metrics. Relatedly, another edge computing resource of computing system 100 (not depicted) can notify model scheduler process 122 (or more generally notify central computing resource 120) that drift has been detected for a third subset of time-series data metrics. While the example provided here involves two additional drift detections, it should be understood there may be many more co-contemporaneous drift detections across many edge computing resources associated with many customers. As alluded to above, model scheduler process 122 can be executed to assign/distribute model training and validation tasks corresponding to these various drift detections to model listener processes 124(1)-(n) in parallel. Such parallel assignment/distribution of model training and validation tasks across multiple model listener processes 124(1)-(n) can improve overall training/validation speed for computing system 100.

Referring now to model listener process 124(1), after being assigned the first model training and validation task, model listener process 124(1) can be executed to perform the first model training and validation task by training instances of stored forecasting models M_1-M_N using (fresh) training time-series data derived from the first subset of time-series data metrics. Here, stored forecasting models M_1-M_N may comprise various types of forecasting models including statistical models, such as AutoArima and Prophet, neural network models such as Long-Short-Term-Memory (LSTM), or any other types of machine learning models used to make predictions.

In various implementations, model listener process 124(1) can be executed to retrieve the instances of stored forecasting models M_1-M_N from a library/database such as the Darts library. Here, the such a library (e.g., the Darts library) can provide storage for forecasting models M_1-M_N. The library can also provide an API that can handle time-series data/time-series data metrics. Use of the library can also facilitate easier comparison between trained instance of forecasting models using statistical indexes such as mean absolute percentage error (MAPE). The library may also facilitate construction/modification of the instances of the stored forecasting models.

As depicted, model listener process 124(1) can be executed to retrieve the first subset of time-series data metrics from time-series database 121, and split the first subset of time-series data metrics into training time-series data and validation time-series data. In various implementations, the training time-series data may be derived from a first time interval of the first subset of time-series data metrics and the validation time-series data may be derived from a second time interval of the first subset of time-series data metrics.

After training the instances of stored forecasting models M_1-M_N using the training time-series data derived from the first subset of time-series data metrics, model listener process 124(1) can be executed to validate their performance. For example, model listener process 124(1) can be executed to compare predictions of the trained instances of stored forecasting models M_1-M_N to corresponding (fresh) validation time-series data also derived from the first subset of time-series data metrics. Model listener process 124(1) can be executed to utilize various statistical comparisons/indexes to make this comparison such as mean absolute percentage error (MAPE). For example, model listener process 124(1) can be executed to compute a MAPE index for each trained instance of forecasting models M_1-M_N. Such a computation may be performed for each constituent time-series data metric of the first subset of time-series data metrics. Model listener process 124(1) can then be executed to compare MAPE indexes across trained instances of forecasting models M_1-M_N and across time-series data metrics.

Based on these comparisons, model listener process 124(1) can be executed to determine that the trained instance of stored forecasting model M_2 has lowest prediction error for predicting the first subset of time-series data metrics among the trained instances of stored forecasting models M_1-M_N. Responsive to determining the trained instance of stored forecasting model M_2 has a lower prediction error for predicting the first subset of time-series data metrics than the first forecasting model (i.e., the forecasting model currently deployed at edge computing resource 110 to predict the first subset of time-series data metrics), model listener process 124(1) can be executed to update model registry database 125 of central computing resource 120 with parameters of the trained instance of stored forecasting model M_2. As alluded to above, this may comprise uploading a configuration file storing the trained parameters of the instance of stored forecasting model M_2.

As described above, responsive to central computing resource 120 updating model registry database 125 with the parameters of the trained instance of stored forecasting model M_2, edge computing resource 110 can execute download model scheduler process 114 to download the parameters of the trained instance of stored forecasting model M_2 and upload such parameters to a model configuration database 115 of edge computing resource 110. Forecast engine process 113 can then be executed to retrieve the parameters of the trained instance of stored forecasting model M_2 from model configuration database 115 and deploy the trained instance of stored forecasting model M_2 to predict the first subset of time-series data metrics. In this example, the trained instance of stored forecasting model M_2 may replace the first forecasting model which became less suited for predicting the post-drift first subset of time-series data metrics.

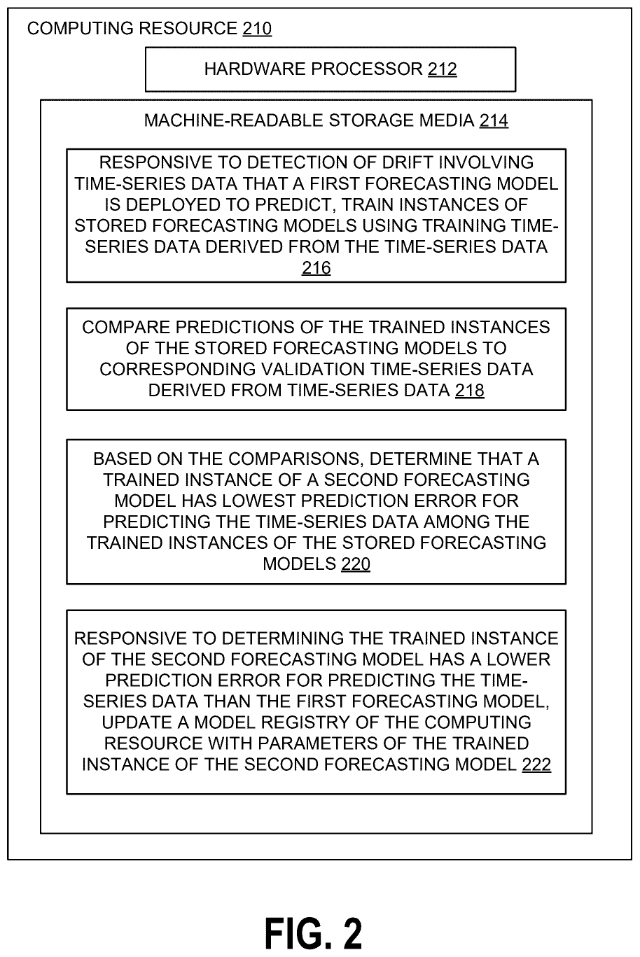

FIG. 2 illustrates an example computing resource 210 for automatically training, validating, and selecting forecasting models, in accordance with various examples of the presently disclosed technology. In certain implementations, computing resource 210 may be a central computing resource (e.g., a centralized, cloud-computing cluster) analogous to central computing resource 120 of FIGS. 1A-1B. In these implementations, computing resource 210 may comprise a central computing resource within a larger computing system that includes one or more edge computing resources (in some of these implementations computing resource 210 and the edge computing resources may be implemented using containerized environments). However, in other implementations computing resource 210 need not be a central computing resource. For example, computing resource 210 may be a computing resource deployed at the edge (i.e., an edge computing resource).

Referring now to FIG. 2, computing resource 210 may be, for example, a server computer, a controller, or any other similar computing component capable of processing data. In the example implementation of FIG. 2, computing resource 210 includes a hardware processor 212, and machine-readable storage medium for 214.

Hardware processor 212 may be one or more central processing units (CPUs), semiconductor-based microprocessors, and/or other hardware devices suitable for retrieval and execution of instructions stored in machine-readable storage medium 214. Hardware processor 212 may fetch, decode, and execute instructions, such as instructions 216-222. As an alternative or in addition to retrieving and executing instructions, hardware processor 212 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 214, may be any electronic, magnetic, optical, or other physical storage device that contains or stores executable instructions. Thus, machine-readable storage medium 214 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 214 may be a non-transitory storage medium, where the term “non-transitory” does not encompass transitory propagating indicators. As described in detail below, machine-readable storage medium 214 may be encoded with executable instructions, for example, instructions 216-222. Further, although the instructions shown in FIG. 2 are in an order, the shown order is not the only order in which the instructions may be executed. Any instruction may be performed in any order, at any time, may be performed repeatedly, and/or may be performed by any suitable device or devices.

As depicted, responsive to detection of drift involving time-series data that a first forecasting model is deployed to predict, hardware processor 212 can execute instruction 216 to train instances of stored forecasting models using training time-series data derived from the time-series data. In some implementations, the first forecasting model may be deployed at an edge computing resource. In certain of these implementations the edge computing resource may detect the drift involving the time-series data. In some implementations computing resource 210 and the edge computing resource may be part of a common computing system (e.g., computing system 100 of FIGS. 1A-1B). As alluded to above, in various implementations the time-series data may comprise a subset of time-series data metrics, although this need not be the case.

Hardware processor 212 can execute instruction 218 to compare predictions of the trained instances of the stored forecasting models to corresponding validation time-series data derived from time-series data. In certain implementations the training time-series data and the validation time-series data may be derived from different time intervals of the time-series data.

Based on the comparisons, hardware processor 212 can execute instruction 220 to determine that a trained instance of a second forecasting model has lowest prediction error for predicting the time-series data among the trained instances of the stored forecasting models.

Responsive to determining the trained instance of the second forecasting model has a lower prediction error for predicting the time-series data than the first forecasting model, hardware processor 212 can execute instruction 222 to update a model registry of computing resource 210 with parameters of the trained instance of the second forecasting model. As alluded to above, in some implementation the edge computing resource can download the parameters of the trained instance of the second forecasting model from the model registry database and deploy the trained instance of the second forecasting model for predicting the time-series data.

As described in conjunction with FIGS. 1A-1B, in certain implementations hardware processor 214 may execute machine-readable instructions of a model scheduler process to: (a) retrieve model training and validation tasks from a task database of computing resource 210, wherein a first model training and validation task utilizes the time-series data; and (b) assign the model training and validation tasks to model listener processes, wherein the first model training and validation task is assigned to a first model listener process. In some implementations, hardware processor 212 can execute machine-readable instructions of the model scheduler process to assign the model training and validation tasks to the model listener processes in parallel. In certain implementations, hardware processor 212 can execute machine-readable instructions of the first model listener process to perform the first model training and validation task.

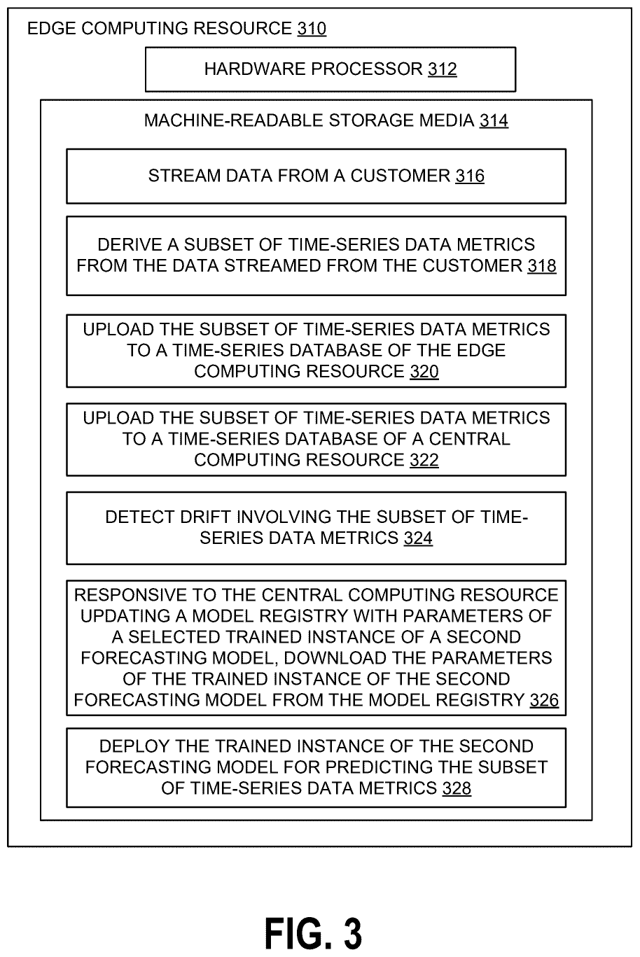

FIG. 3 illustrates an example edge computing resource 310 for deriving subsets of time-series data metrics, detecting drift involving the subsets of time-series data metrics, and automatically deploying instances of new forecasting models trained to predict the (drifted) subsets of time-series data metrics, in accordance with various examples of the presently disclosed technology. Edge computing resource 310 may be analogous in form and function to edge computing resource 110 of FIGS. 1A-1B. In these implementations, edge computing resource 310 may be implemented within a larger computing system (e.g., computing system 100 of FIGS. 1A-1B) that includes a central computing resource (e.g., central computing resource 120 of FIGS. 1-A-1B, computing resource 210 of FIG. 2, etc.).

Referring now to FIG. 3, edge computing resource 310 may be, for example, a server computer, a controller, or any other similar computing component capable of processing data. In the example implementation of FIG. 3, edge computing resource 310 includes a hardware processor 312, and machine-readable storage medium for 314.

Hardware processor 312 may be one or more central processing units (CPUs), semiconductor-based microprocessors, and/or other hardware devices suitable for retrieval and execution of instructions stored in machine-readable storage medium 314. Hardware processor 312 may fetch, decode, and execute instructions, such as instructions 316-328. As an alternative or in addition to retrieving and executing instructions, hardware processor 312 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 314, may be any electronic, magnetic, optical, or other physical storage device that contains or stores executable instructions. Thus, machine-readable storage medium 314 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 314 may be a non-transitory storage medium, where the term “non-transitory” does not encompass transitory propagating indicators. As described in detail below, machine-readable storage medium 314 may be encoded with executable instructions, for example, instructions 316-328. Further, although the instructions shown in FIG. 3 are in an order, the shown order is not the only order in which the instructions may be executed. Any instruction may be performed in any order, at any time, may be performed repeatedly, and/or may be performed by any suitable device or devices.

As depicted, hardware processor 312 can execute instruction 316 to stream data from a customer.

Hardware processor 312 can execute instruction 318 to derive a subset of time-series data metrics from the data streamed from the customer. Deriving the subset of time-series data metrics from the streamed customer data may comprise: (a) indexing data points of the streamed data in time order to generate time-series data metrics; and (b) logically grouping the subset of time-series data metrics together according to a heuristic. In certain implementations the heuristic may comprise logically grouping time-series data metrics derived from a common customer sub-system together as a subset of time-series data metrics.

Hardware processor 312 can execute instruction 320 to upload the subset of time-series data metrics to a time-series database of the edge computing resource. Relatedly, hardware processor 312 can execute instruction 322 to upload the subset of time-series data metrics to a time-series database of a central computing resource (e.g., central computing resource 120 of FIGS. 1A-1B, computing resource 210 of FIG. 2, etc.).

In certain examples, hardware processor 312's execution of instructions 318-322 may correspond with executing machine-readable instructions of a data switch process of edge computing resource 310.

Hardware processor 312 can execute instruction 324 to detect drift involving the subset of time-series data metrics. In various implementations this may comprise comparing, within a time interval, historical predictions of a first forecasting model deployed to predict the subset of time-series data metrics against corresponding portions of the (actual) subset of time-series data metrics. Increasing magnitude of deviations between predicted and actual values (e.g., deviations over a threshold value) may indicate the occurrence of data drift. As alluded to above, this detection of drift may trigger the central computing resource to train, validate, and select a second forecasting model to predict the (drifted) subset of time-series data metrics.

Responsive to the central computing resource updating a model registry with parameters of a selected trained instance of the second forecasting model, hardware processor 312 can execute instruction 326 to download the parameters of the trained instance of the second forecasting model from the model registry.

Hardware processor 312 can then execute instruction 328 to deploy the trained instance of the second forecasting model for predicting the (drifted) subset of time-series data metrics.

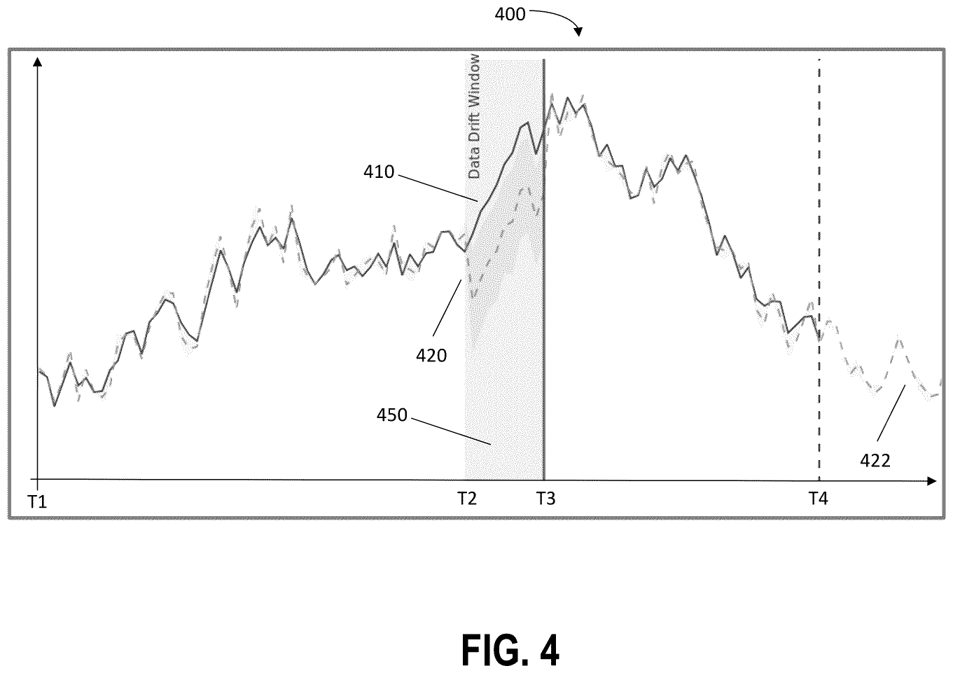

FIG. 4 depicts an example graph 400 comparing predictions of forecasting models against actual/historical data the forecasting models are deployed to predict, in accordance with various examples of the presently disclosed technology.

The x-axis of graph 400 represents time duration. The y-axis of graph 400 represents scalar values for a particular parameter (e.g., voltage of a temperature sensor in a machine, temperature in London, etc.). Here, time-indexed scalar values for the particular parameter (i.e., time-indexed data points describing the particular parameter) may be referred to as a first time-series data metric.

Curve 410 in graph 400 (i.e., the curve depicted with a solid line) represents actual/historical values for the first time-series data metric. Curve 420 in graph 400 (i.e., the curve depicted in dashed lines from time T1 to time T3) represents predictions of a first forecasting model deployed to predict the first time-series data metric. Curve 422 in graph 400 (i.e., the curve depicted in dashed lines after time T3) represents predictions of a second forecasting model deployed to predict the first time-series data metric after drift has been detected.

As depicted, the predictions of the first forecasting model track very closely with the actual/historical values for the first time-series data metric between times T1 and T2. However, starting at time T2, the predictions of the first forecasting model begin to deviate significantly from the actual/historical values for the first time-series data metric. As visual representation of such deviation, curves 410 and 422 begin to separate in drift window 450 (i.e., the shaded region between times T2 and T3). As described above, the predictions of the first forecasting model may begin to deteriorate at time T2 due to the occurrence of drift. As used herein “drift” (sometimes referred to as “data drift”) may refer to statistical properties of a time-series data metric (e.g., the first time-series data metric) that change over time in unforeseen ways. These unforeseen changes can cause predictions of a forecasting model (e.g., the first forecasting model) deployed to predict the drifting time-series data metric (e.g., the first time-series data metric) to deteriorate.

As an example, the first time-series data metric may relate to an operational parameter of a machine, such as voltage of a temperature sensor. A change to the voltage sensor, or another structural/functional modification to the machine may result in drift. The first forecasting model may be less-suited for predicting the first time-series data metric after such drift. Accordingly (and as described above), responsive to detecting drift involving the first time-series data metric examples of the presently disclosed technology can automatically train, validate, and select an instance of a second forecasting model to predict the (drifted) first time-series data metric.

Examples can utilize various techniques to detect drift involving the first time-series data metric. For instance, examples can compare, within a time interval (e.g., between times T2 and T3), historical predictions of the first forecasting model to corresponding actual/historical values for the first time-series data metric. If examples detect deviations over a predetermined threshold, they may determine the occurrence of drift. In other implementations, examples can detect drift using other techniques such as using Kolmogorov-Smirnov (K-S) test, using a Population Stability Index, using the Page-Hinkley method, or using other drift detection techniques/algorithms.

After the second forecasting model is trained/validated, examples can deploy the second forecasting model (i.e., the trained instance of the second forecasting model) to predict the (drifted) first time-series data metric. As depicted in graph 400, the second forecasting model is deployed at time T3. As can be seen in graph 400, the predictions of the second forecasting model track much closer to the actual/historical values of the (drifted) first time-series data metric. Time T4 may represent current time-after which there are only predictions of the second forecasting model.

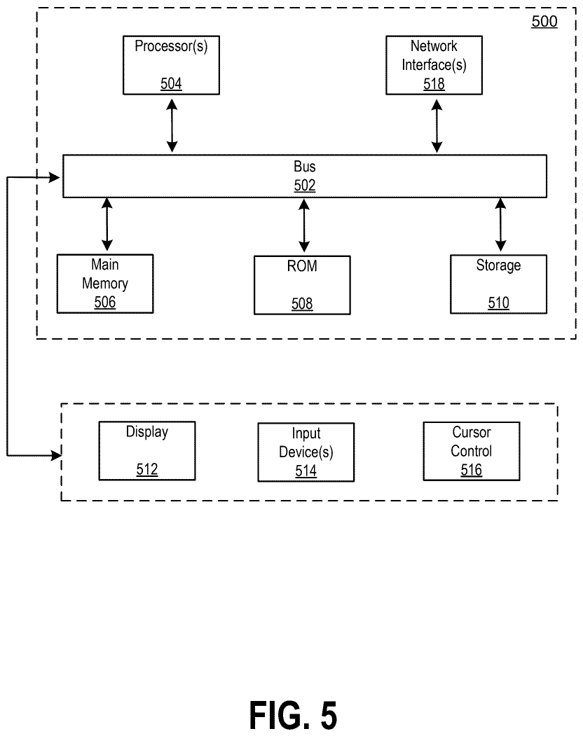

FIG. 5 depicts a block diagram of an example computer system 500 in which various of the embodiments described herein may be implemented. For example, edge computing resource 110 and central computing resource 120 of FIGS. 1A-1B, computing resource 210 of FIG. 2, and edge computing resource 310 of FIG. 3, may be implemented using computing system 500. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical indicators that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical indicators that carry digital data streams. The indicators through the various networks and the indicators on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system comprising:
a computing resource operable to execute machine-readable instructions to:
responsive to detection of drift involving time-series data that a first forecasting model is deployed to predict, train instances of stored forecasting models using training time-series data derived from the time-series data, and
responsive to determining a trained instance of a second forecasting model has a lower prediction error for predicting the time-series data than the first forecasting model, update a model registry database of the computing resource with parameters of the trained instance of the second forecasting model.

2. The system of claim 1, further comprising an edge computing resource at which the first forecasting model is deployed, wherein the edge computing resource is operable to execute machine-readable instructions to:
detect the drift involving the time-series data; and
responsive to the computing resource updating the model registry database with the parameters of the trained instance of the second forecasting model, download the parameters of the trained instance of the second forecasting model from the model registry database and deploy the trained instance of the second forecasting model for predicting the time-series data.

3. The system of claim 2, wherein detecting the drift involving the time-series data comprises:
comparing, within a time interval, historical predictions of the first forecasting model to corresponding portions of the time-series data.

4. The system of claim 1, wherein the computing resource is further operable to execute machine-readable instructions to:
determine the trained instance of the second forecasting model has lowest prediction error for predicting the time-series data among the trained instances of the stored forecasting models.

5. The system of claim 4, wherein determining the trained instance of the second forecasting model has the lowest prediction error for predicting the time-series data among the trained instances of the stored forecasting models comprises:
comparing predictions of the trained instances of the stored forecasting models to corresponding validation time-series data derived from the time-series data.

6. The system of claim 5, wherein the training time-series data and the validation time-series data are derived from different time intervals of the time-series data.

7. The system of claim 2, wherein:
the time-series data comprises a subset of time-series data metrics; and
the edge computing resource is operable to execute machine-readable instructions of a data switch process to:
stream data from a customer;
derive the subset of time-series data metrics from the data streamed from the customer;
upload the subset of time-series data metrics to a time-series database of the edge computing resource; and
upload the subset of time-series data metrics to a time-series database of the computing resource.

8. The system of claim 7, wherein deriving the subset of time-series data metrics from the data streamed from the customer comprises:
indexing data points of the data in time order to generate time-series data metrics; and
logically grouping the subset of time-series data metrics together according to a heuristic.

9. The system of claim 8, wherein the heuristic comprises logically grouping time-series data metrics derived from a common customer sub-system together as a subset of time-series data metrics.

10. The system of claim 1, wherein:
the computing resource is operable to execute machine-readable instructions of a model scheduler process to:
retrieve model training and validation tasks from a task database of the computing resource, wherein a first model training and validation task utilizes the time-series data; and
assign the model training and validation tasks to model listener processes, wherein the first model training and validation task is assigned to a first model listener process; and
the computing resource is operable to execute machine-readable instructions of a first model listener to perform the first model training and validation task by performing the training and model registry database updating steps of claim 1.

11. The system of claim 8, wherein the computing resource is operable to execute machine-readable instructions of the model scheduler process to assign the model training and validation tasks to the model listener processes in parallel.

12. The system of claim 2, wherein the computing resource and the edge computing resource are implemented using containerized computing environments.

13. A method comprising:
responsive to detection of drift involving a subset of time-series data metrics that a first forecasting model is deployed to predict, training instances of stored forecasting models using training time-series data derived from the subset of time-series data metrics; and
responsive to determining a trained instance of a second forecasting model has a lower prediction error for predicting the subset of time-series data metrics than the first forecasting model, updating a model registry database with parameters of the trained instance of the second forecasting model.

14. The method of claim 13, further comprising:
determining the trained instance of the second forecasting model has lowest prediction error for predicting the subset of time-series data metrics among the trained instances of the stored forecasting models.

15. The method of claim 14, wherein determining the trained instance of the second forecasting model has the lowest prediction error for predicting the subset of time-series data metrics among the trained instances of the stored forecasting models comprises:
comparing predictions of the trained instances of the stored forecasting models to corresponding validation time-series data derived from the subset of time-series data metrics.

16. The method of claim 15, wherein the training time-series data and the validation time-series data are derived from different time intervals of the subset of time-series.

17. The method of claim 13, further comprising:
executing a model scheduler process to:
retrieve model training and validation tasks from a task database, wherein a first model training and validation task is associated with the subset of time-series data metrics, and
assign the model training and validation tasks to model listener processes, wherein the first model training and validation task is assigned to a first model listener process; and
executing the first model listener process to perform the first model training and validation task by performing the training and model registry database updating steps of claim 13.

18. The method of claim 17, wherein executing the model scheduler process to assign the model training and validation tasks to the model listener processes comprises:
executing the model scheduler process to assign the model training and validation tasks to the model listener processes in parallel.

19. Non-transitory computer-readable medium storing instructions, which when executed by one or more processors, cause the one or more one or more processors to:
responsive to detection of drift involving a subset of time-series data metrics that a first forecasting model is deployed to predict, train instances of stored forecasting models using training time-series data derived from the subset of time-series data metrics; and
responsive to determining a trained instance of a second forecasting model has a lower prediction error for predicting the subset of time-series data metrics than the first forecasting model, update a model registry database with parameters of the trained instance of the second forecasting model.

20. The non-transitory computer-readable medium storing instructions of claim 17, further comprising an instruction to:
determine the trained instance of the second forecasting model has lowest prediction error for predicting the subset of time-series data metrics among the trained instances of the stored forecasting models.
